(19) United States
(12) Patent Application Publication
(10) Pub. No.: US 2019/0147394 A1
(43) Pub. Date: May 16, 2019

(54) METHOD AND APPARATUS FOR CAPTURING THE CONTENT OF A STORAGE SPACE

(71) Applicant: BSH HAUSGERÄTE GMBH, München (DE)

(72) Inventors: JOHANNES SCHLOSSER, UNTERSCHNEIDHEIM (DE); MARCUS WIEDEMANN, HERBRECHTINGEN (DE); BERND HEGER, HAUNSHEIM (DE)

(21) Appl. No.: 16/098,323

(22) PCT Filed: May 11, 2017
(86) PCT No.: PCT/EP2017/061339

§ 371 Date: Nov. 1, 2018

(30) Foreign Application Priority Data
May 31, 2016 (DE) 10 2016 209 440.8

(51) Int. Cl. G06Q 10/08; F25D 29/00; G06F 16/22

(52) U.S. Cl. CPC G06Q 10/087; F25D 29/005; F25D 2500/06; F25D 2700/06; F25D 2700/08; G06F 16/22

(57) ABSTRACT

A method for capturing the content of a storage space, particularly a freezer compartment and a normal refrigerating compartment or larder of a refrigeration appliance, includes providing a set of contactlessly readable data storage media, each of the data storage media including information specific thereto, physically connecting one of the data storage media to a stored product, generating a data record linking the information specific to the data storage medium to information specific to the stored product connected to the data storage medium, storing the data record in a database, reading those data storage media located in the storage space, and outputting the stored product-specific information from those entries in the database for which the data storage medium-specific information was read. A refrigeration appliance, a management unit and a computer program product are also provided.

The present invention relates to a method for capturing the content of a storage space, in particular a storage space of a refrigeration appliance, and to means for carrying out the method.

DE 100 60 154 A1 already proposed equipping a refrigeration appliance with a management unit, which is designed to compare an actual stored stock in the storage space of the refrigeration appliance with a desired stored stock and to transmit a list of needs drawn up as a result of the comparison to a remote terminal, in order optionally to arrange for replenishing of the stored stock. To capture the actual stock, a reader is provided which is designed to read an ID of a stored item when it is added to the actual stored stock, and to read it a second time when it is removed again.

Such a system is only practicable for the management of objects provided with a machine-readable ID, such as for instance most packaged foodstuffs. It is only able to a limited degree to recognize differently labeled foodstuffs from different manufacturers as the same and take them into account when drawing up the list of needs. The system cannot identify if a foodstuff, though present, has exceeded its expiration date and should no longer be used. Foodstuffs in unlabeled containers, in particular those which have been put into a different container or further processed by the user him- or herself, are not captured.

The object of the present invention is therefore to provide a method which allows a consumer, with a minimum of effort, comprehensively to monitor their stocks of consumer goods in a storage space, in particular a storage space of a refrigeration appliance.

The object is achieved by a method having the steps:

a) providing a set of contactlessly readable data storage media, wherein each of the data storage media contains information specific thereto,
b) physically connecting one of the data storage media to a stored product,
c) generating a data record which links information specific to the data storage medium with information specific to the stored product connected to the data storage medium, and storing the data record in a database,
d) reading those data storage media which are located in the storage space and
e) outputting the product-specific information stored in the database from those database entries for which the data storage medium-specific information was read.

The information specific to the data storage medium has merely to allow the data storage medium to be distinguished from all the other data storage media of the set; this information is linked with a specific stored product only once the data storage medium is connected to the stored product and the data record generated. This operation may be repeated as often as desired for one and the same data storage medium. Since it may also be performed by a private consumer, capture of stored products which have been put into a different container or even home-produced is also possible. With the assistance of a reader arranged in the storage space, the data storage media in the storage space may also be read without the consumer being present. The stored product-specific information may therefore be output fully automatically, for example to a retailer who is intended to supply further specific stored products based on this information; it may also be output at the user's request, in particular by remote data transfer if said user wishes to be provided with an overview of what he/she has in stock and make decisions about buying replacements.

If the data storage medium is fastened to a container, the physical connection in step b) may encompass filling the container with the refrigerated product. Since the consumer in any event generally places home-made foodstuffs into a container before storing it in a refrigerator, or transfers foodstuffs from opened sales packaging which cannot be securely reclosed, this step is not associated with any additional effort on the part of the consumer.

If step d) is performed every time the storage space is closed, it may thereby be identified whether changes have taken place to the stored stock.

If, for instance, the read data storage media include one for which no stored product-specific information is saved in the database, then this must have newly entered the storage space while the door was open. In this case, stored product-specific information may be requested of the consumer to generate a data record relating to this data storage medium, i.e. a request may be issued to the consumer to indicate what type of stored product is associated with the data storage medium or what is in the container provided with the data storage medium.

An interface needed to output this request or input the stored product-specific information may be provided on the refrigeration appliance or on the storage space itself. However, it may be less expensive and more convenient for the consumer to use a mobile data terminal networked with the reader and the database, such as for instance a tablet computer or a smartphone.

If, in step d), a data storage medium with which a data record in the database is associated is not found in the storage space, it may be concluded therefrom that the stored product provided with the relevant data storage medium has been removed. In the simplest case, it may then be assumed that the stored product has been consumed, and the associated data record may be deleted; the data storage medium is then available again to be used for another stored product. However, if the stored product has not been consumed or not completely consumed and, at a later point in time, is returned to the storage space, then the data record would also have to be regenerated at this point in time. It is therefore preferable for the data record for a removed refrigerated product not to be deleted immediately but rather to be marked as removed. If, when step d) is subsequently repeated, the data storage medium in question is found once again in the storage space, the existing data record may be reused, or a request may be output to the consumer in which the latter is requested to decide whether the existing data record should continue to apply or a new one should be generated.

A quick, convenient way of generating the data record is to photograph the stored product. If in particular, as mentioned above, the request for stored product-specific information is sent to a mobile data terminal, the camera installed in most such terminals may be used for this purpose.

Reading of the data storage medium in step d) preferably proceeds wirelessly, since the data storage medium does not have to be specifically oriented relative to the reader for this purpose. Cheaply available RFID transponders may here in particular be considered as possible data storage media, but other standards such as for instance Bluetooth may also be used.

In order to generate the data record for a stored product in step c), it is likewise appropriate to read the data storage medium-specific information from the data storage medium associated with the stored product. This may take place as described above, by the associated data storage medium being read by the storage space reader and the consumer then being requested to complete the data record with the stored product-specific information. Such a procedure is however prone to error if a plurality of data storage media arrive newly in the storage space at the same time; in this case, the consumer may incorrectly associate the stored product-specific information with the data storage medium-specific information. If a plurality of items are to be simultaneously newly stored, it is therefore advantageous to provide a reader with which the data storage medium-specific information of a specific data storage medium may be purposefully input and completed with the associated stored product-specific information, in particular by placing a data storage medium in the reader's capture range. This reader may be of the same type as the reader in the storage space. In order however to make it easier for the consumer to monitor which of a plurality of closely adjacent data storage media is read, it is advantageous for the data storage medium also to comprise the information specific thereto in optically readable form, and for reading of the data storage medium-specific information in step c) to proceed optically. The above-mentioned camera built into a mobile data terminal may advantageously also be used for this purpose. A further advantage of optical information capture lies in the fact that the data storage medium-specific information and the stored product-specific information of a stored item may be contained in a common image and thus a single image may suffice for generation of a data record for a stored item.

An entry which contains the date of introduction of the stored product into the storage space or a date derived therefrom, in particular a date by which the stored product needs to be consumed, should conveniently also be included in the data record. The storage date may also be made available by a conventional mobile data terminal together with an image of the stored product.

The invention further provides a refrigeration appliance, in particular a domestic refrigeration appliance, with a storage space and a reader for contactless reading of data storage media, which is arranged on the storage space in order to read data storage media located in the storage space, a management unit, which is capable of being networked with a reader of a refrigeration appliance and a mobile data terminal and is designed to carry out at least steps c) to e) of the above-described method, and a computer program product with program code means which enable a computer to operate as the above-described management unit.

Further features and advantages of the invention are revealed by the following description of exemplary embodiments, made with reference to the appended drawings, in which:

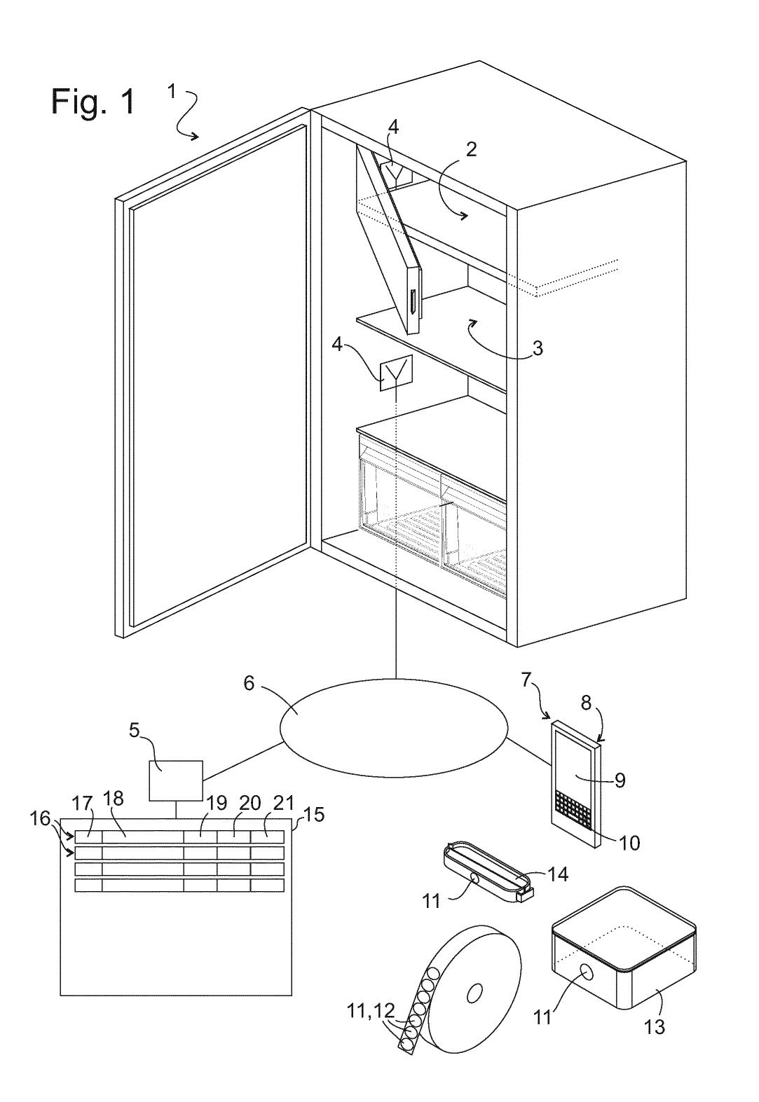

FIG. 1 shows components of a system for performing the method according to the invention; and

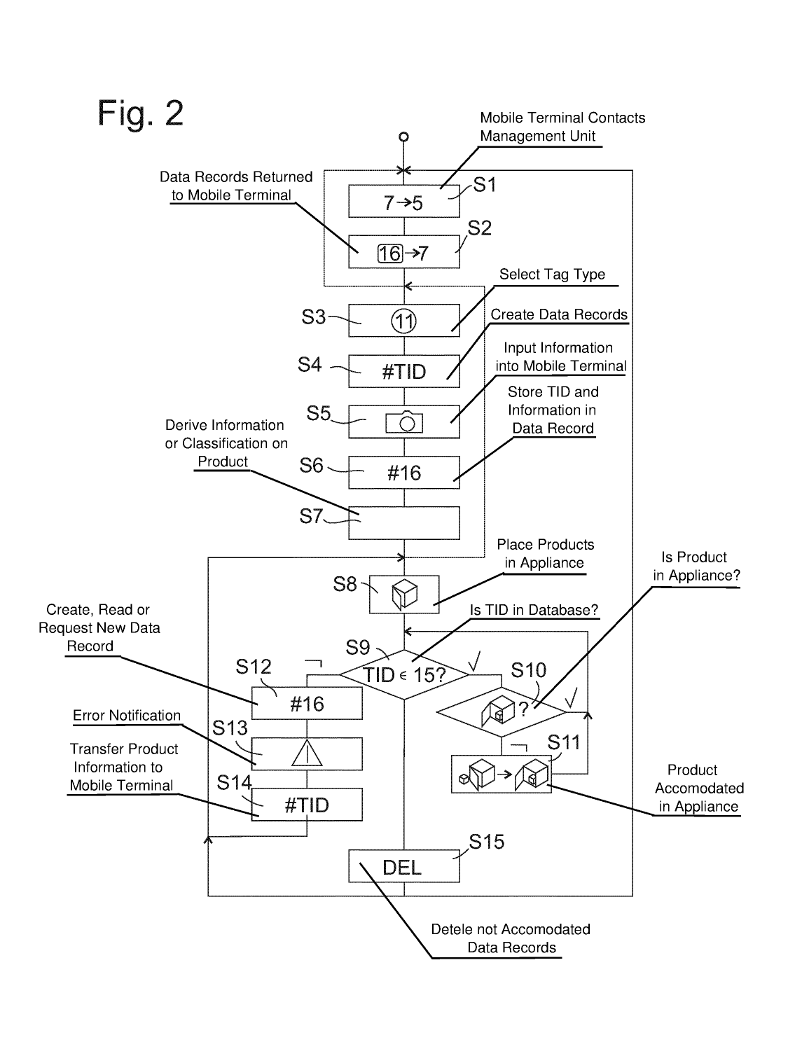

FIG. 2 shows a flow chart of a preferred embodiment of the method.

FIG. 1 shows a refrigeration appliance 1, here a combined domestic refrigeration appliance with a freezer compartment 2 and a larder compartment 3. Each compartment 2, 3 may form a storage space as defined in the above description, or the two compartments 2, 3 together may be regarded as one storage space.

An RFID transceiver 4 is mounted on each compartment 2, 3 as a reader for communication with RFID tags on refrigerated products stored in the compartments. The compartments 2, 3 may be shielded from one another, such that each transceiver 4 only receives signals from the tags in its compartment.

The transceivers 4 are connected with a management unit 5. The management unit 5 may be built into the refrigeration appliance 1; preferably it is separate from the refrigeration appliance 1 and connected with the transceiver 4 via a network 6. The management unit 5 may for example be implemented on a PC which belongs to the same household as the refrigeration appliance 1 and is connected with the transceivers 4 thereof for example via WLAN. It may also be located on a computer belonging to a service provider, wherein the network 6 may then comprise a public telecommunications network or the Internet.

A mobile terminal 7 such as for instance a smartphone or a tablet computer is connected to the same network 6. In a manner known per se, the mobile terminal 7 has a built-in camera 8, a display screen 9 and an interface 10 for input of alphanumeric information.

The refrigeration appliance's accessories include a set of RFID tags 11. These may be provided in different forms, for example in the form of inexpensive stickers 12, which can be stuck to any desired solid surfaces, for example of disposable packaging, and disposed of with the packaging once the contents have been consumed. Other tags 11 are attached permanently to re-usable refrigerated goods containers 13 or to re-usable clips 14 which may be used to close freezer bags. Each tag 11 stores information TID which is specific to it and distinguishes it from all the other tags.

A database 15 of the management unit 5 contains a data record 16 for each tag 11 located in one of the compartments 2, 3, each data record 16 comprising a plurality of entries 17 to 21. Entry 17 in each case contains the TID of the tag 11. Entry 18 contains details about the refrigerated product, with which the tag 11 in question is physically connected. Entry 19 specifies the compartment 2 or 3 in which the tag 11 is located; it may be absent if each compartment 2, 3 has its own database associated with it. The function of entries 20 and 21 will be explained in relation to the description of the method.

The method shown in FIG. 2 comes into play at a point in time at which the user of the refrigeration appliance 1 decides to shop for supplies. With his or her mobile terminal 7, said user makes contact in step S1 with the management unit 5 in order to view the database 15. The user may request all the data records 16 from the management unit 5, but it is also conceivable that he or she might transmit a search filter to the management unit 5 in step S1, such that in step S2 the latter returns only specific data records 16 to the terminal 7, for example the user may selectively request display of the data records 16 relating to fresh fruit and vegetables, meat and sausages or dairy products depending on the supermarket aisle in which he or she is located at the time, so as to be able rapidly to determine which products may need to be acquired from the relevant aisle.

These steps may be repeated multiple times until the user has completed all of his or her shopping.

Once the user is home, he or she then loads his or her purchases into the refrigeration appliance 1. To this end, the user selects (S3) a suitable type of tag 11 for each product which does not already come with a manufacturer's tag 11. For prepackaged products for which storage life would be impaired if transferred to another container, such as for instance fresh milk, yogurt or the like, a sticker tag 11 is suitable, which is stuck to the product's packaging. For products from fresh food counters, such as for instance cheese or cold cuts, which are conventionally packed in bags at the supermarket, a clip 14 with tag may be attached, or the products may be transferred into a container 13 with tag. Ultimately, the user has a plurality of refrigerated product items each provided with a tag 11.

Connection with an RFID tag 11 is superfluous for those products acquired by the user which have already been provided with such a tag by the manufacturer. Such tags may contain the same article-specific information as the barcodes conventionally captured at supermarket checkouts to identify the purchase price to be paid by the customer and to monitor supermarket stocks of the article.

In the next method step S4 the user has various possible ways of creating a data record 16 in the database 15 for each of these refrigerated product items. If the mobile terminal 7 supports NFC communication, the user may hold it sufficiently close to a tag 11 for the information TID to be transferred wirelessly directly from the tag 11 to the terminal 7. In order, in the subsequent step S5, to input information relating to the refrigerated product identified with the tag 11 into the terminal 7, the user may use the interface 10 thereof, or he or she may take a photo of the refrigerated product using the camera 8.

In step S6, the TID and the refrigerated product-related information are forwarded to the database 15 and there stored in a common data record 16 as entries 17, 18. Entry 20 of this data record is set to a value which identifies the refrigerated product item in question as not yet accommodated in the refrigeration appliance 1, and the current date and time are recorded in entry 21.

If only the image produced by the camera 8 has been transmitted as refrigerated product-related information or if, in addition to the information input by the user via the interface 10, provision may be made for the management unit 5 to derive text information or classification information describing the refrigerated product from the image (S7), on the basis of which the new entries 16 may be searched through with the aid of filters next time the user makes a purchase and transmitted selectively in step S2. This process of derivation may be based on the recognition of characters, barcodes or QR codes visible in the image; it is also conceivable for the management unit 5 to search for images similar to the transmitted image on the Internet in order to draw conclusions about the item depicted from keywords associated with these images and in this way acquire text information which may be transmitted with lower bandwidth than an image to the terminal 7 on subsequent repetition of step S2 and there be displayed on a small display surface.

In a preferred embodiment of the invention, the information TID from each tag 11 is also printed in optically readable form, for example as a barcode or QR code, on the surface of the tag 11. The user may then photograph it when taking an image of the refrigerated product using the camera 8, such that the above-described steps S4 of acquiring the TID and S5 of capturing the refrigerated product-specific information for the user may be carried out by taking a single photo. The TID may then be extracted in binary form from the image data by the management unit 5 by recourse to known electronic image processing methods. Steps S4-S6 and optionally S7 are repeated for each refrigerated product item provided with a tag 11.

Once data records 16 have been created for all the new refrigerated product items, the user places them in the refrigeration appliance 1. Once the user has finished doing this, he or she closes the door of the refrigeration appliance 1. When the management unit 5 detects this in step S8, it begins to poll the RFID tags 11 in the compartments 2, 3 via the transceivers 4 and request their TIDs.

Once the TID of one of the tags in the refrigeration appliance 1 has been received, the management unit 5 checks in step S9 whether this TID is present in one of the data records 16 of the database 15. If so, and if the entry 20 for this data record shows the associated refrigerated product item as accommodated in the refrigeration appliance 1 (S10), then it relates to a refrigerated product which was already present in the refrigeration appliance 1 before the door was opened; in this case, no further measures are necessary, and the method returns to step S9 to process a further received TID.

If entry 20 shows the refrigerated product item as not accommodated in the refrigeration appliance 1, then it is one of the new refrigerated product items. In this case, the entry is changed to “accommodated in the refrigeration appliance” (S11), and the method returns to step S8, in order to process a further TID, if one is present. If, as shown in FIG. 1, the refrigeration appliance has a plurality of compartments 2, 3 each with associated transceiver 4, then entry 19 may record from which transceiver 4 the TID was received, i.e. in which compartment 2 or 3 the refrigerated product item is located.

If the TID is not contained in any of the data records 16, it must come from a refrigerated product item whose tag 11 has not previously undergone steps S4-S6 or for which the printed TID has been incorrectly identified. In this case, in step S12 the management unit creates a new data record 16 containing the TID as entry 17. If the TID comes from a tag 11 attached to a product by the manufacturer, then the product-related information needed for entry 18 may also be read from the tag 11 or requested from a publicly accessible database via the network 6; in this case, the resultant information is added to the data record 16 and the management unit 5 returns to step S8, in order to process a further TID, if one is present. If no product-related information can be obtained in the described ways, then it most probably comes from a tag 11 which the user has him- or herself connected to the refrigerated product item as described above. The management unit 5 therefore generates an error notification in step S13, which it sends to the terminal 7 or to a user interface of the refrigeration appliance 1.

If just one refrigerated product item has been introduced while the door was last open, then only this can be the cause of the error notification. In this case, all that is needed is for the user, in response to the error message, to remove the refrigerated product item once again and take a photo of it, which the management unit then adds to the data record created in step S12.

If at the same time precisely one data record 16 is set to “not yet accommodated in the refrigeration appliance 1”, then there is a high probability that the TID of this data record has been incorrectly identified. In step S14, the management unit 5 then transfers the refrigerated product-specific information of this data record 16 to the terminal 7, such that the user may readily identify the refrigerated product item in question and record its TID a second time. If the user removes the refrigerated product item in question for this purpose and then closes the door again after putting it back in the refrigeration appliance 1, this brings about a return to method step S8.

Once a predetermined waiting time has elapsed after the door was last closed, the method moves to step S15. This waiting time is typically longer than the time during which the refrigerated product would remain outside the refrigeration appliance over a meal, for example 2 hours. After this time, all the data records 16 which are still set to “not accommodated in the refrigeration appliance 1” are deleted in step S15.

If the user takes items out of the refrigeration appliance 1 in order to place them on the table for a meal and closes the door again, this is recognized by the management unit 5 and causes a return to step S8. The removed items are identified in S9 due to the fact that their tags 11 are unable to supply any TID to the management unit 5; accordingly, the entry 20 in their data records 16 is set to “not accommodated in the refrigeration appliance”.

After the meal, the refrigerated product which has not been consumed is put back in the refrigeration appliance, and the method again returns to step S8. Since a data record 16 with correct TID is present for all the items which have been put back, steps S10 and S11 are run through for each of these items; data input by the user is not necessary.

Items which have been consumed and therefore not put back cannot be supply a TID to the management unit 5 in step S9. Their entries 20 therefore retain on the status “not accommodated in the refrigeration appliance 1”, with the consequence that they are deleted when step S15 is next run through. If such an item's tag 11 is to be reused, for example after washing and refilling of the container 12 to which it is attached, a new data record may be created for it in steps S4-S6. If it is placed in the refrigeration appliance without these steps having previously been run through, it will be identified as foreign in S9 and trigger the error message S13.

Alternatively, a third status may be defined in addition to the above-mentioned statuses “not accommodated in the refrigeration appliance 1” and “accommodated in the refrigeration appliance”, in order to identify a refrigerated product which has been removed and probably consumed, and in step 15 the data record of such a refrigerated product which has been returned is not deleted, as described above, but rather is set to this third status. Then if, at a later point in time, the RFID tag 11 whose TID equates to the data storage medium-specific information 17 of this data record is found in the refrigeration appliance again, a request may be output to the user as to whether the old data record, including its refrigerated product-specific information, is to be reused or a data record is to be generated.

The date assigned in step S6 to each tag 11 properly introduced into the refrigeration appliance 1 does not change, providing the corresponding data record 16 remains in existence. The user can use this date in step S1 as a query criterion to identify which refrigerated product has been in the refrigeration appliance the longest and may need to be consumed as soon as possible.

On the basis of the refrigerated product-specific information input by the user in step S5 or the information derived therefrom in S6, the management unit 5 may also automatically, optionally taking account of entry 19, estimate a recommended maximum storage time for a refrigerated item, add this to the date of storage and store the result in entry 21 of the data record 16 for this refrigerated item. This enables the management unit 5 automatically to output a notification to the terminal 7 when the calculated date is approaching or has arrived, so as to remind the user that the refrigerated item in question needs to be consumed. Adding the entry 18 for the data record in question to the notification makes it easier for the user to identify the refrigerated item.

A cupboard, shelving or an entire room may be storage spaces for the purposes of the method according to the invention; application of the above-described method thereto would not cause a person skilled in the art any difficulties and is therefore not explained in detail here.

### REFERENCE SIGNS

1 Refrigeration appliance
2 Freezer compartment
3 Larder compartment
4 Transceiver
5 Management unit
6 Network
7 Mobile terminal
8 Camera
9 Display screen
10 Interface
11 RFID tag
12 Sticker
13 Refrigerated product container
14 Clip
15 Database
16 Data record
17 Entry (TID)
18 Entry (refrigerated product-specific)
19 Entry (compartment)
20 Entry (accommodated)
21 Entry (date)

1-15. (canceled)

16. A method for capturing contents of a storage space or a storage space of a refrigeration appliance, the method comprising the following steps:
a) providing a set of contactlessly readable data storage media, each data storage medium containing information specific to the data storage medium;
b) physically connecting one of the data storage media to a stored product;
c) generating a data record linking information specific to the data storage medium with information specific to the stored product connected to the data storage medium, and storing the data record in a database;
d) reading those data storage media located in the storage space; and
e) outputting the stored product-specific information stored in the database from those database entries for which the data storage medium-specific information was read.

17. The method according to claim 16, which further comprises:
fastening the data storage medium to a container; and
filling the container with the refrigerated product when carrying out the physical connection in step b).

18. The method according to claim 16, which further comprises carrying out at least step d) each time the storage space is closed.

19. The method according to claim 16, which further comprises:
f) checking whether the read data storage media include an unsaved data storage medium for which no stored product-specific information is saved in the database; and
g) if so, requesting stored product-specific information needed to generate a data record for the unsaved data storage medium.

20. The method according to claim 19, which further comprises sending the request for stored product-specific information to a mobile data terminal.

21. The method according to claim 16, which further comprises:
h) identifying or deleting (S15) a data record having a data storage medium not found in the storage space in step d).

22. The method according to claim 16, which further comprises photographing the stored product and saving a photograph of the stored product in the step of generating the data record.

23. The method according to claim 16, which further comprises wirelessly reading the data storage medium in step d).

24. The method according to claim 16, which further comprises reading data storage medium-specific information from the data storage medium together with inputting the specific information for the stored product associated with the data storage medium, in the generation of the data record in step c).

25. The method according to claim 24, which further comprises using a reader located outside the storage space in the reading of the data storage medium-specific information in step c).

26. The method according to claim 24, which further comprises:
including the information specific to the data storage medium in optically readable form in the data storage medium; and
optically reading the data storage medium-specific information in step c).

27. The method according to claim 16, which further comprises carrying out step c) by including an entry in the data record containing a date of introduction of the stored product into the storage space or a date derived from the date of introduction.

28. A refrigeration appliance or domestic refrigeration appliance, comprising:
a storage space; and
a reader for contactless reading of data storage media disposed at said storage space.

29. A management unit to be networked with a reader of a refrigeration appliance and a mobile data terminal, the management unit being configured to carry out the following steps:
generating a data record linking information specific to a data storage medium with information specific to a stored product connected to the data storage medium, and storing the data record in a database;
reading the data storage media located in a storage space; and
outputting the stored product-specific information stored in the database from database entries for which data storage medium-specific information was read.

30. A non-transitory computer-readable program product with instructions stored thereon, that when executed by a processor, enable a computer to operate as the management unit according to claim 29.
